(19) United States
(12) Patent Application Publication
(10) Pub. No.: US 2015/0059989 A1
(43) Pub. Date: Mar. 5, 2015

(54) OVERHEAD DOOR SPRING ALERT SAFETY SYSTEM

(71) Applicant: HERMAN GUTIERREZ, SUNNYVALE, CA (US)

(72) Inventor: HERMAN GUTIERREZ, SUNNYVALE, CA (US)

(21) Appl. No.: 14/298,876

(22) Filed: Jun. 6, 2014

Related U.S. Application Data
(60) Provisional application No. 61/870,778, filed on Aug. 27, 2013.

(51) Int. Cl. E06B 9/80

(52) U.S. Cl. CPC E06B 9/80
USPC 160/10; 160/405

(57) ABSTRACT

A safety system for overhead garage and like door structures having a counterbalance spring structure including one or more coil springs, which comprises devices for detecting the breaking of a door counterbalance spring and alerting a human operator to a spring failure. The system may include communication capabilities for remote notification of the fault and other information, and may include devices for preventing operation of a motorized door opener until the fault is cleared.

### CROSS-REFERENCE TO RELATED APPLICATIONS

The present application claims priority to and incorporates U.S. Provisional Patent Application Ser. No. 61/870,778 filed Aug. 27, 2013.

### FIELD OF THE INVENTION

This invention relates to an overhead garage door safety system and particularly to an overhead door safety system that detects the breaking of a door counterbalance spring and informs a human operator of the failure via local visual and/or audible alert and/or via remote notification, and which may also prevent operation of a motorized door opener until the fault is cleared.

### BACKGROUND OF THE INVENTION

Overhead garage doors are generally equipped with one or more counterbalance springs by which the weight of the door is mostly offset to reduce the forces required for opening or closing the door. This counterbalanced arrangement is critical for making door operation safe, whether by human operator or motorized opener, due to the greatly reduced operating forces then needed for opening or closing the door. These counterbalance springs are relatively powerful and are repeatedly put under great tension with each door closure. Garage doors are often operated several times a day for many years with little maintenance attention, so a counterbalance spring breaking while the door is opening or closing is not rare.

A significant safety hazard is created if an overhead garage door counterbalance spring breaks, as the door may then fall onto someone causing serious injury or death or fall onto something, like an automobile, causing expensive damage. Additionally, a motorized opener may become damaged by the resulting excess forces and the door itself and even the building may become damaged as a result of a counterbalance spring failure.

Similar counterbalance spring structures are used with overhead door applications other than garages, including commercial building access and truck van or trailer roll-up doors, with a similar safety hazard due to a breaking counterbalance spring.

This safety hazard is well known and has been addressed in prior art regarding garage doors with devices to act as a brake or motion lock to prevent a door falling should a spring be broken, or to restrain a broken spring from flinging around, or to notify a person if a door remains open when supposed to be closed, or to notify that maintenance service is due. Broken spring detection has been attempted in general by sending electric current through the springs while monitoring electrical changes. For doors with motorized openers there are methods to detect the effect of a loss of spring assist when operating the opener, but these systems do not directly detect a spring breaking as opposed to it being broken, or notify a human door operator of the danger prior to use, nor do they disable a motorized opener due to a counterbalance spring breaking without first applying power to try to move the door.

### SUMMARY OF THE INVENTION

The primary objective of the present invention is to provide an overhead door safety system that will detect the breaking of a counterbalance spring and alert a human operator to the failure.

A particular benefit of this invention is it provides an inexpensive garage door spring alert safety system that can be easily installed onto an existing overhead garage door assembly, whether or not a motorized opener is in use, to add the benefits of breaking counterbalance spring detection and notification.

Notwithstanding the above, this invention can also be incorporated into new overhead garage and like door assemblies or counterbalance spring assemblies and/or motorized opener assemblies, for original or replacement installations. This invention may also be utilized with truck van and trailer roll-up door assemblies to warn operators of a broken counterbalance spring in those structures.

Briefly, this invention provides a sensor attached at or near an overhead door counterbalance spring that senses the energy suddenly released when the spring breaks while under tension. The signal from said sensor, due to the shock of the breaking spring, is detected by an electronic control circuit device that in response initiates an operator alert function. Multiple sensors may be provided for installations if deemed advantageous.

The operator alert function of this invention typically utilizes devices for a visual and/or audible signal to notify a human operator locally that a counterbalance spring has broken. The operator alert function may also utilize communication means, including wired and wireless devices, to remotely notify a person of the failure, for example via text or email message or via tie-in to a security system.

The operator alert function may also utilize additional devices to prevent operation of a motorized opener for that door until the fault is cleared. For example, a relay or switch can be used during a fault condition to open the power circuit to the motorized opener, either built into the motorized opener assembly or remotely located between the opener power input and the building power source. Other motorized opener disable circuits are clearly possible, including those using wireless communication.

The control unit, in addition to said control circuit and operator alert devices, incorporates switching means for turning the system on, resetting the operator alert function, silencing the audible signal, and/or other appropriate inputs, and the power supply means for this safety system. The control unit may also incorporate means to count door opening/closing operations or track time elapsed to indicate when door or opener maintenance services are due, as an additional user benefit.

A preferred embodiment of this invention utilizes an electronic shock sensor to detect the energy released from a breaking door counterbalance spring and provide a signal to the electronic control circuit. The combination of sensor and control circuit is designed to ignore typical vibrations that are incurred with normal door operation and is designed to only respond to the high magnitude sudden shock energies originating with a counterbalance spring breaking. Other sensor types to detect the energy released by a breaking spring are not precluded by this selection.

One embodiment of this invention has a sensor attached to or near the non-rotating end of each counterbalance spring by use of an adhesive, such as epoxy or pressure sensitive adhesive tape, or by use of a spring clip, with leads flying to the remotely mounted control unit. Utilizing one sensor for each spring does not preclude other combinations of sensors and springs. Another embodiment of this invention has one sensor incorporated into the control unit with the entire control unit mounted onto the end of the door spring torsion shaft, which also permits torsion shaft rotation sensing for sensing door operations. Other sensor location and attachment means and control unit locations are certainly possible, including use of wireless sensors and/or incorporating the control unit functions into a motorized opener assembly.

A preferred embodiment of this invention utilizes a battery contained in the control unit to provide electrical power to operate the system. Battery power may simplify system installation compared to utilizing a building power source. With modern electronics a sufficiently long system functional life is available with battery power and the system can be designed to alert the operator at end of battery life. Nevertheless, utilizing a building power source is not precluded by this selection.

### DESCRIPTION OF THE DRAWINGS

FIG. 1 is an inside view of a typical overhead garage door assembly.

FIG. 2 is a view of a basic installation of the invention on an overhead door assembly where sensors with flying leads are utilized.

FIG. 3 is a block representation of the devices composing the basic invention in FIG. 2.

FIG. 4 is a view of a basic installation of the invention on an overhead door assembly where mounted on the end of the torsion shaft.

FIG. 5 is a block representation of the devices composing the basic invention in FIG. 4.

### DETAILED DESCRIPTION OF THE BEST MODE

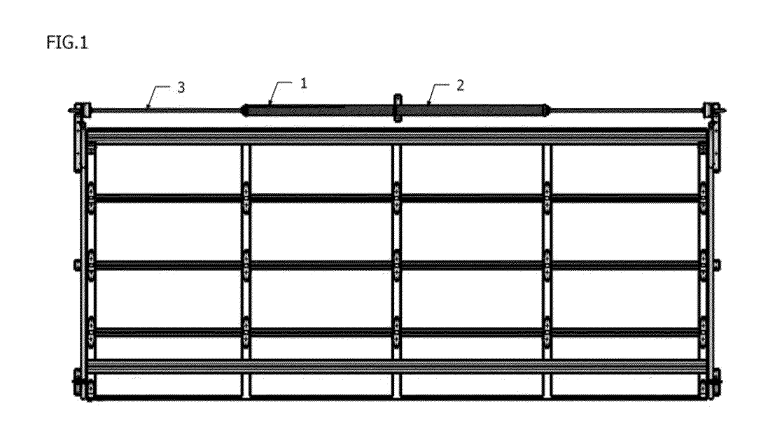

FIG. 1 is an inside view of a typical overhead garage door assembly; in this case a two-vehicle sized model that includes two counterbalance springs 1 & 2 located over the door and on a torsion shaft 3. Other typical overhead garage door assemblies utilize just one or more than two counterbalance springs.

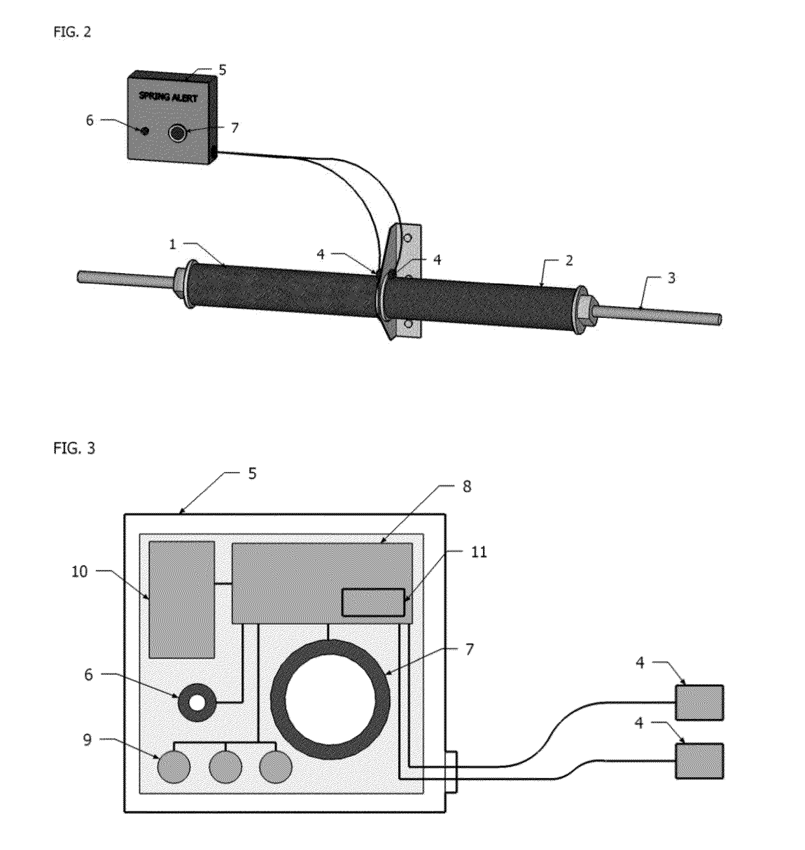

FIG. 2 shows the basic invention installed on a typical overhead door assembly where sensors with flying leads are utilized. Only the counterbalance springs 1 & 2 with the torsion shaft 3 and nearby mounting hardware of the door assembly are shown. One sensor 4 is attached to or near the non-rotating end of counterbalance spring 1 and another sensor 4 is attached to or near the non-rotating end of the other counterbalance spring 2. The sensors 4 are attached by adhesive means (not shown) such as epoxy or pressure sensitive adhesive tape, which permits easy installation on existing units, but other means of attachment are possible, such as spring clips, and are not precluded by this selection.

The sensors 4 are electronic shock sensor devices shown with electrical cabling connecting to the control unit 5, but integrated sensor/control units or wireless sensors or other sensor types such as accelerometers are not precluded by this representation. A minimum of only one sensor is required by the invention, although one or more sensors for each counterbalance spring in an assembly may be preferred. These sensors are used to detect the energy suddenly released when a counterbalance spring breaks while under tension. The high spring tension used in these door systems store substantial energy and when a spring breaks while under tension the sudden energy release is severe and can be detected apart from the normal vibrations the system generates during use. A basic aspect of the invention is to detect a counterbalance spring breaking by sensing the energy suddenly released by the breakage.

The control unit 5 is shown with both a visual device 6, such as an indicator light, and an audible device 7, such as a beeper or siren, for locally signaling a human operator during the operator alert function. However, any one means of alert is sufficient, whether audible, visual, or otherwise, including communication to a remote device.

FIG. 3 is a block diagram of the devices composing the basic invention shown in FIG. 2. The control unit 5 shown includes a visual device 6, audible device 7, control circuit 8, one or more input switches 9, and the power supply 10. Connected to the control unit 5 are one or more sensors 4 as previously discussed.

The power supply 10 of the best mode is a battery, which avoids having to connect to the building power supply during installation. However, building power can be used if desired and the power supply 10 could include components located outside of the control unit 5.

The control circuit 8 may incorporate an output module 11 to include communications means, wired or wireless, to remotely notify a person of the failure, and/or to operate a disable function for a motorized door opener, and/or to remotely provide other information about the system.

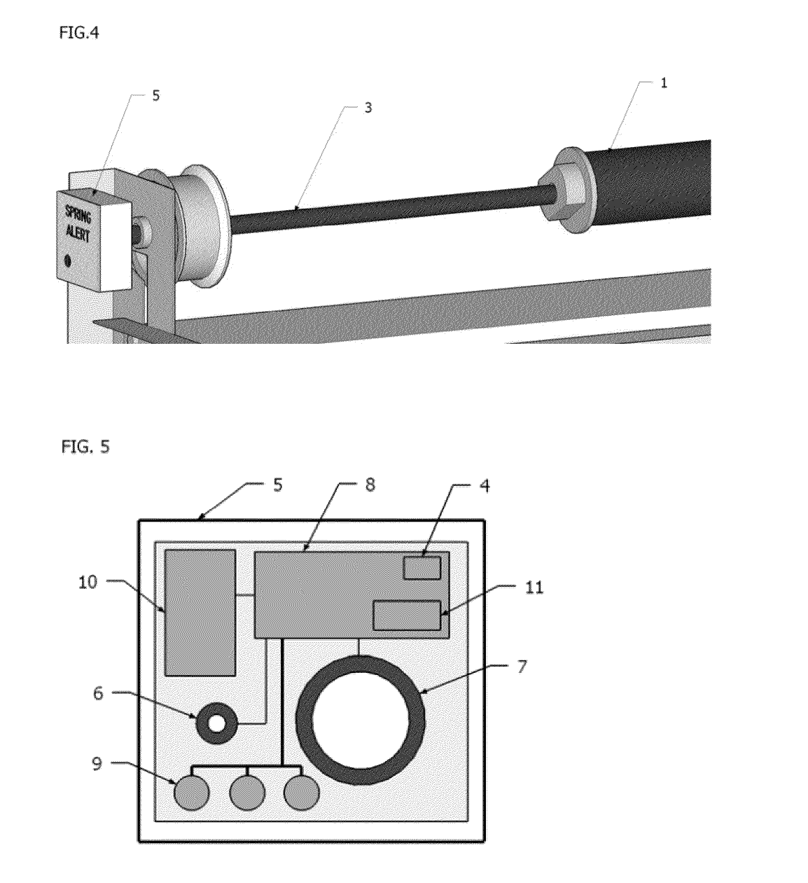

FIG. 4 shows the basic invention installed on a typical overhead door assembly where mounted on the end of the torsion shaft. Only an end of a counterbalance spring 1 and the torsion shaft 3 and the nearby hardware of the door assembly are shown. The control unit 5 includes the sensors in this embodiment with the entire assembly mounted on the end of the torsion shaft 3. Enough of the sudden energy release of a counterbalance spring breaking is transmitted through the torsion shaft 3 to be detected by this version of the invention. Additionally, the control unit 5 rotates with the torsion shaft during door opening and closing with this design, and such movement can be detected for use counting door operations or for other possible use.

FIG. 5 is a block diagram of the devices composing the basic invention shown in FIG. 4. The control unit 5 shown includes a visual device 6, audible device 7, control circuit 8, one or more input switches 9, and the power supply 10. Included with the control circuit 8 are one or more sensors 4 for detecting a breaking counterbalance spring, and possibly an output module 11 as discussed for FIG. 3.

What is claimed is:

1. A safety system for overhead garage and like door structures having a counterbalance spring structure including one or more coil springs comprising:
devices for detecting the breaking of a door counterbalance spring and alerting an operator to a spring failure event.

2. A safety system for overhead garage and like door structures having a counterbalance spring structure including one or more coil springs comprising:
one or more sensors for detecting the energy released by the breaking of a door counterbalance spring; and
a control circuit sensitive to said sensors for alerting a human operator to a spring failure event.

3. A safety system for overhead garage and like door structures having a counterbalance spring structure including one or more coil springs comprising:
one or more electronic sensors that detect the energy suddenly released by the breaking of a door counterbalance spring; and
an electronic control circuit sensitive to said sensors that enables an alert function to notify a human operator of a spring failure event.

4. The safety system of claim 3 wherein the electronic sensors are shock or accelerometer type sensors.

5. The safety system of claim 3 wherein the electronic sensors are remote from the control circuit and communicate with the control circuit via wired or wireless means.

6. The safety system of claim 3 wherein the electronic sensors are integral with the control circuit.

7. The safety system of claim 3 wherein visual and/or audible signal devices are provided for designating spring failure and/or other system status.

8. The safety system of claim 3 wherein means wired or wireless are provided for communicating system status with external devices or systems.

9. The safety system of claim 3 wherein means are provided to stop operation of a motorized door operator due to a spring failure event.

10. A method for detecting the breaking of a counterbalance spring of an overhead door structure comprising:
one or more sensors located at or near said spring that detect the energy released by the breaking of said spring; and
a control circuit sensitive to said sensors that alerts a human operator to a spring failure event.

11. A method for detecting the breaking of a counterbalance spring of an overhead door structure comprising:
one or more electronic sensors located at or near said spring that detect the energy suddenly released by the breaking of said spring; and
an electronic control circuit sensitive to said sensors that enables an alert function that notifies a human operator of a spring failure event.
